(19) United States
(12) Patent Application Publication
(10) Pub. No.: US 2006/0127543 A1
(43) Pub. Date: Jun. 15, 2006

(54) Non-invasive colorimetric ripeness indicator

(75) Inventors: Robert A. Klein, Albuquerque, NM (US); Mark R. Riley, Tucson, AZ (US); Dominic M. DeCianne, Tucson, AZ (US); Navaporn Srinavakul, Bangkapi (TH)

Correspondence Address: QUARLES & BRADY STREICH LANG, LLP, ONE SOUTH CHURCH AVENUE, SUITE 1700, TUCSON, AZ, 85701-1621, US

(73) Assignee: Arizona Board of Regents on behalf of The University of Arizona, Tucson, AZ (US)

(21) Appl. No.: 11/273,654

(22) Filed: Nov. 14, 2005

Related U.S. Application Data
(60) Provisional application No. 60/627,547, filed on Nov. 12, 2004.

(51) Int. Cl. A23L 1/27

(52) U.S. Cl. 426/263

(57) ABSTRACT

Apparatus and methods for detecting ethylene levels as an indicator of produce ripeness. An ethylene-permeable substrate having a calorimetric reagent disposed thereon is placed adjacent to an item of produce such that ethylene levels are detected and result in the reagent changing color.

### CROSS-REFERENCE TO RELATED APPLICATIONS

This application claims the benefit of priority to U.S. Provisional Application No. 60/627,547 entitled “Sticker for Color Based Measurements for Determination of Fruit Ripeness” filed on Nov. 12, 2004, the entire contents of which are incorporated by reference.

### BACKGROUND OF THE INVENTION

1. Field of the Invention

The invention relates generally to ripeness indicators and more particularly to apparatus and methods for non-invasively indicating produce ripeness through an ethylene-related color change.

2. Description of the Related Art

Ethylene, sometimes known as the “death” or “ripening hormone,” plays a regulatory role in many processes of plant growth, development, and eventually death. Produce (i.e., fruits, vegetables, and flowers) contain receptors that serve as bonding sites to absorb free atmospheric ethylene molecules. Ethylene, which has the molecular structure H₂C═CH₂, differs from most plant hormones in that it is a gas at atmospheric conditions. When produce approach maturity, they release ethylene. Hence, the common practice of placing produce (e.g., a tomato) in a paper bag to hasten ripening is an example of the action of ethylene on produce. It is thought that increased levels of ethylene contained within the bag, released by the produce itself, serves as an autocatalytic stimulant after reabsorption to initiate the production of more ethylene. The overall effect is to hasten ripening, which eventually leads to spoilage.

Among the many changes that ethylene causes is the destruction of chlorophyll. With the breakdown of chlorophyll, the red and/or yellow pigments in the cells of the fruit are unmasked and the fruit assumes its ripened color. However, determination of the most favorable harvest, packing, and storage period(s) cannot reliably be based on subjective, relatively imprecise methods like visual inspection and personal experience. A grower's subjective judgment about which blocks of ripening apples are ready for harvest or post-harvest shipping is often uncertain because of fruit color and condition ambiguity, temperature fluctuation, weather, and other uncontrollable factors.

Ideally, ripeness determination should be non-invasive and applied in the orchard or field (i.e., in situ) or post-harvest. Ethylene gas has a very quick uptake and has been conclusively demonstrated to correlate closely with ripeness. Ethylene production in climacteric fruit may increase as much as 1000-fold during the ripening stage. Reaction of ethylene with metals has been the basis of a number of colorimetric assays for ethylene. Some researchers have used palladium chloride adsorbed on filter paper to measure ethylene. More recently this has been used in so-called Kitagawa tubes, which are used to sample gases. However, these materials and methods tend to be only suitable for measurement of large gas samples. In other words, when this is applied in the field, the results are poor since ethylene released by produce is relatively small and is diluted by air.

There are at present several colorimetric tube devices available for detecting or analyzing ambient ethylene gas levels primarily for industrial and environmental purposes. A hand-held, digital display, battery-operated, low-range ethylene detector for citrus de-greening and spot checks of ethylene levels in storage areas is also available (i.e., the model sold by QA Supplies).

Responding to the limitations of devices that injure or otherwise render a fruit or other produce unfit for marketing, recent research activity in this field is increasingly directed toward determining non-invasive and other non-destructive methods for ascertaining fruit ripeness status. In particular, researchers have developed a variety of commercial and non-commercial sensors based on a wide variety of mechanical, electric, magnetic, or optical principles, including sensors that utilize spectral-optical analysis, electronic noses or sniffers; magnetic resonance, near-infrared transmission spectroscopy, thermal imaging, multispectral imaging, machine vision technology, and firmness detection.

However, many recent attempts to quantify the release of ethylene for ripeness detection purposes involve expensive and time consuming analytical techniques, such as gas chromatography, and various electronic devices that are cumbersome and not easily applied in the field.

In order to be a commercially feasible technology, a calorimetric device must meet several strict requirements. In descending order of importance these include detecting low levels of ethylene (0.1 ppm is a feasible target), stability and insensitivity to confounding factors, rapid response (preferably within minutes), high contrast to permit easy detection, safety and minimal environmental impact, and low cost.

Portable noses or sniffers, for example, utilize electronic components and sensing apparatus that require an operator, a power supply, and a small computer, thereby mitigating efficiency and otherwise complicating rather than enhancing the harvesting process. Similarly, destructive and/or invasive methods often rely on average ethylene release rates, or a range of rates, rather than real-time measurements of individual, representative samples in situ, thereby diluting both reliability and efficiency.

Another technology, the so-called RipeSense™ detection system produced in New Zealand, is marketed as a means to determine the ripeness of pears (packaged 4 per closed plastic box). The device changes color due to the release of volatiles from the fruit over an extended period of time. However, this technology most likely is not sensitive enough to measure ethylene but rather responds to the slow release of aromatic compounds which must accumulate within the plastic box before a color change results. Hence, the produce must be packaged, which makes this system unavailable for in situ (e.g., orchard or field) use.

Poor management of produce ripening, brought about by the lack of information on the release of ethylene, has far-reaching administrative, economic, and marketing consequences. Thus, there is a critical need for a reliable, objective method for determining produce ripeness in the field and in the packing house, for both the continuing success of the individual grower and the industry at large. Accordingly, it continues to be desirable to reliably and inexpensively evaluate ethylene concentrations associated with ripeness in produce and to develop apparatus and methods for clearly indicating produce ripeness based on ethylene levels.

### SUMMARY OF THE INVENTION

The invention relates in general to methods and apparatus for indicating produce ripeness that include an ethylene-permeable substrate and a calorimetric reagent disposed upon the substrate such that the colorimetric reagent changes color in response to ethylene emissions from adjacent produce.

In one aspect, the invention includes a flat, permeable membrane in the form of a patch or “sticker” that self-adheres to the surface of the produce item. The patch is calibrated to reflect the amount of fugitive emissions from a pre-defined quantity of ethylene, a demonstrated fruit ripeness activator, and consequently display a color change indicating ripeness on the visual (external) surface of the detector.

In another aspect of the invention, a kit is provided that includes a plurality of sensors containing an ethylene-responsive colorimetric reagent and a color reference chart so that a user can readily identify a color change corresponding to a particular degree of ripeness. In one embodiment, the color reference chart is disposed upon or otherwise part of the sensor to make visual comparisons easier.

Still another aspect of the invention involves a multi-layered apparatus for detecting and indicating produce ripeness. An ethylene permeable outer substrate and inner substrate contain a colorimetric reagent and are placed adjacent to an item of produce through an adhesive or a structure, such as a hole in the substrates or a loop attached to the apparatus.

By translating the produce's natural ripening timetable into a simple, easy-to-read colorimetric form, this invention offers a unique, previously undeveloped response to the commercial fruit (e.g., apples) market's need for a quick, inexpensive, reliable measurement of fruit ripeness in situ. The sensor is designed to measure ripeness of each individual produce item on the tree or plant or at select times post harvest.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 conceptually illustrates a sensor of the invention indicating a change in ripeness.

FIG. 2 depicts in a schematic exploded view an embodiment of the invention featuring multiple layers.

FIG. 3 depicts in elevational view a second embodiment of the invention.

FIG. 4 shows a variation on the embodiment illustrated in FIG. 2.

FIG. 5 illustrates a third embodiment of the invention.

FIG. 6 depicts an all-in-one color reference chart and ripeness indicator.

FIG. 7 is a schematic depiction of a sensor of the invention as used in situ.

FIG. 8 depicts data resulting from use of the invention upon apples.

FIG. 9 shows an apparatus of the invention undergoing a color change over time.

FIG. 10 illustrates an ethylene specificity test carried out on an apparatus of the invention.

FIG. 11 illustrates a kit embodiment of the invention.

FIGS. 12 and 13 show chemical reactions that occur in some embodiments of the invention.

FIG. 14 depicts a color scale based on a Durapore™ membrane exposed to apples.

### DETAILED DESCRIPTION OF THE PREFERRED EMBODIMENTS

The invention generally relates to a method and apparatus for a non-destructive, non-invasive calorimetric sensor apparatus designed to reliably, quickly, and inexpensively visually indicate produce ripeness in situ (e.g., on the tree or plant), as well as at other points during processing, storage, or distribution. Preferably, the invention includes an ethylene-permeable substrate, a means for locating the substrate adjacent to the produce item, and a colorimetric reagent disposed upon the substrate.

As used herein, the term adjacent means on or in near proximity to. In the context of the chemical reaction that takes place between the calorimetric reagent of the invention and ethylene, near proximity means a distance that allows an accurate and reliable detection of ethylene levels emissions from individual produce and is preferably 0-10 millimeters.

The fundamental approach of the invention involves reaction of ethylene released by produce which leads to a range of color change in a colorimetric compound in direct relation to the concentration of ethylene. Applicable concentrations of detection are 0.1 to 1.0 ppm ethylene for produce pre-harvest and 1.0 to 100 ppm for produce post-harvest. Of course, the colors and configurations used on the embodiments described herein are for illustration purposes and are not limited to a specific color or configuration. Preferably, the color(s) used should contrast with the color of the produce item (e.g., the sensor apparatus is white when unripe produce is yellow but turns purple when produce ripens and begins turning red) so as to be easy to read.

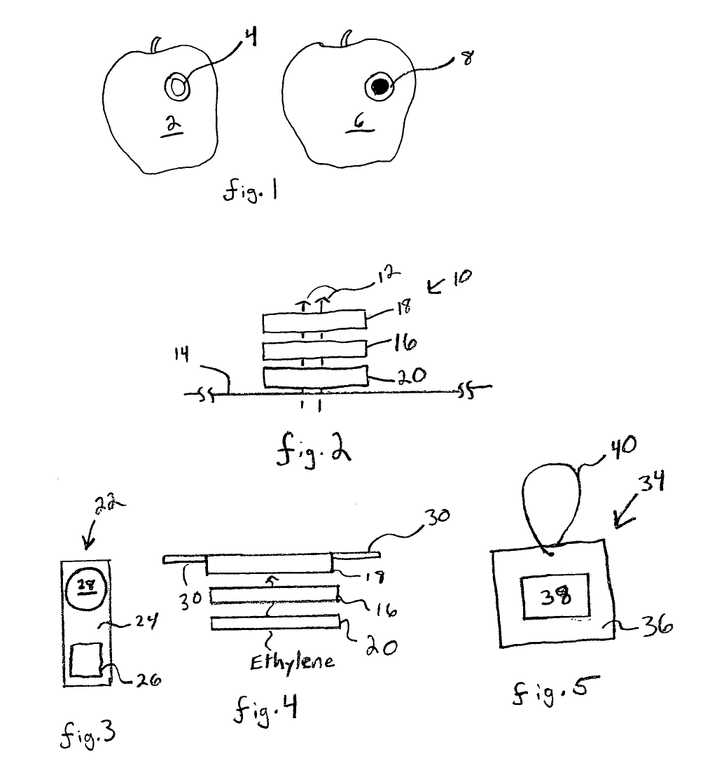

Turning to the figures, FIG. 1 conceptually illustrates a sensor of the invention indicating a change in ripeness. Apple 2 has attached to it a sticker embodiment of the invention that displays an indication of “unripeness” (light color 4), while the sticker of apple 6 displays an indication of ripeness (dark color 8). In this manner, the invention allows the selection of produce at a desired state of maturity.

FIG. 2 depicts in a schematic exploded view an embodiment of the invention in which multiple layers of substrate are used to envelop the colorimetric reagent. The two layers of the sensor 10 are permeable to the ethylene (arrows 12) emitted from produce item 14 such that the ethylene can react with a colorimetric reagent 16. Surrounding the colorimetric reagent 16 are outer substrate 18 and inner substrate 20. Preferably, the inner and outer substrates are made from materials that substantially exclude moisture and oxygen (for example, nitrocellulose) to improve the stability of the calorimetric reagent 16. Also preferably, the outer substrate is made from a material (e.g., transparent Mylar) that substantially excludes ultraviolet radiation to further protect the stability of reagent 16. Adhesive 21 (such as white glue) on the bottom of lower substrate 20 allows for removable attachment of sensor 10 to produce 14. A complete sensor of the invention thus can be made in a variety of ways, including heat sealing, adhering, or integrally forming the upper and lower substrates together to envelop the calorimetric reagent.

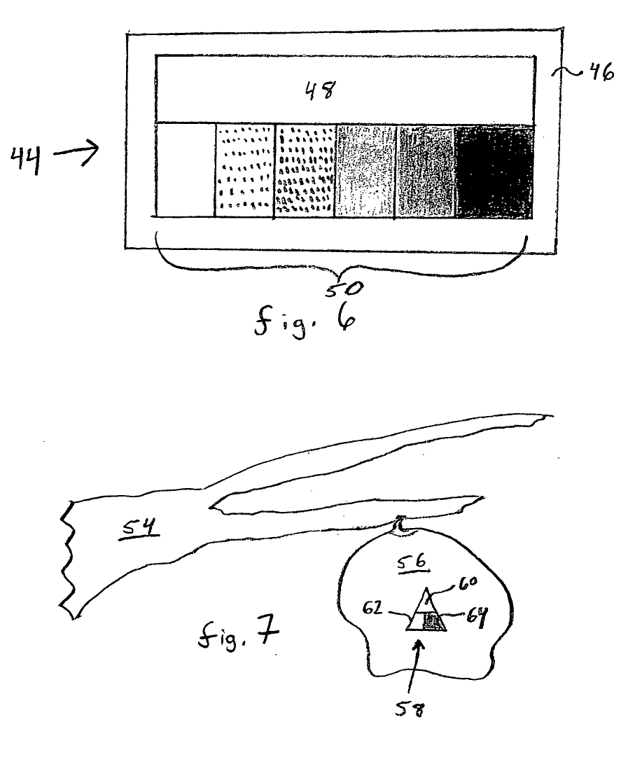

FIG. 3 depicts in elevational view an apparatus 22 that hangs from a stem of an item of produce (not shown). The apparatus 22 includes a substrate 24 that contains a calorimetric reagent 26. A hole 28 disposed through the substrate 24 provides a convenient means for locating the apparatus 22 adjacent to a produce item.

As seen in FIG. 4, a variation on the embodiment illustrated in FIG. 2 further includes adhesive flaps 30 disposed upon the sides of the upper substrate 18. Upper substrate 18 and lower substrate 20 provide a sealed arrangement around the calorimetric reagent 16, with upper substrate 18 being transparent or translucent so that a change in color can be visually perceived. The flaps 30 allow the sensor to be more easily detached from the produce item because not as much surface area is engaged therewith as would be if the entire lower substrate 20 were adhered.

FIG. 5 illustrates another embodiment of the invention. Sensor 34 includes a substrate 36 and a colorimetric reagent 38 disposed thereon. Attached to the top of substrate 36 is a loop structure 40. Preferably, loop structure 40 is elastic so that it may expand to be placed around a variety of objects, such as a large stem, tree branch, or the item of produce itself. In this manner, the sensor 34 may be located adjacent to a produce item in situ, during packaging, or at a retail display.

Turning to FIG. 6, an all-in-one color reference chart and ripeness indicator is shown. The apparatus 44 has a substrate 46 upon which a calorimetric reagent 48 has been disposed. Below calorimetric reagent 48 is color reference chart 50, which contains a range of colors that have been found by tests or calibration to be reliable indications of a particular degree of ripeness. While a separate color reference chart could always be provided, this embodiment is particularly useful to reduce wasted resources in that it minimizes subjectivity while providing multiple times where picking might be appropriate (e.g., early, ripe, and late picking times).

FIG. 7 is a schematic depiction of a sensor of the invention as used in situ. A section 54 of a tree branch is shown upon which produce 56 hangs. Attached to produce 56 is apparatus 58, which includes an area containing calorimetric reagent 60 and a simplified color reference chart made up of two sections, light indication 62 (unripe) and dark indication 64 (ripe).

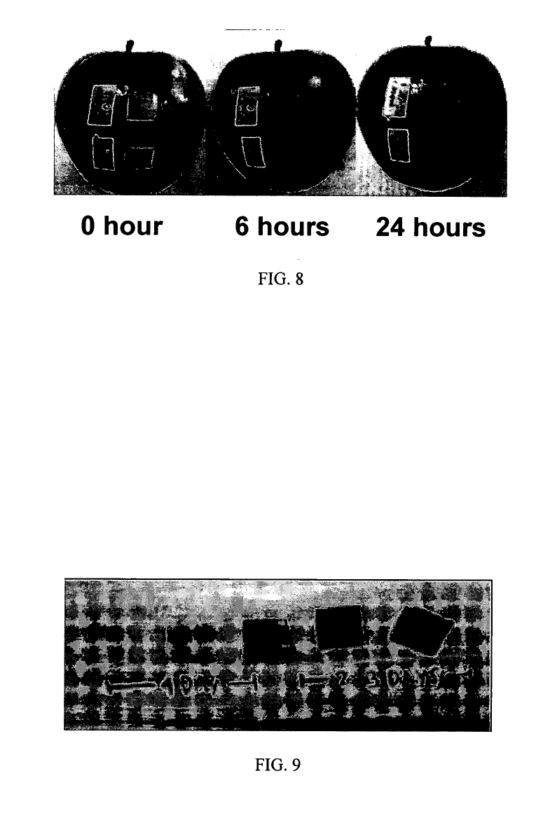

Testing of the apparatus of the invention has taken place on a variety of produce. As seen in FIG. 8, data resulting from use of the invention upon apples reveals that relatively fast (6 hours and 24 hours) changes in ripeness can be detected.

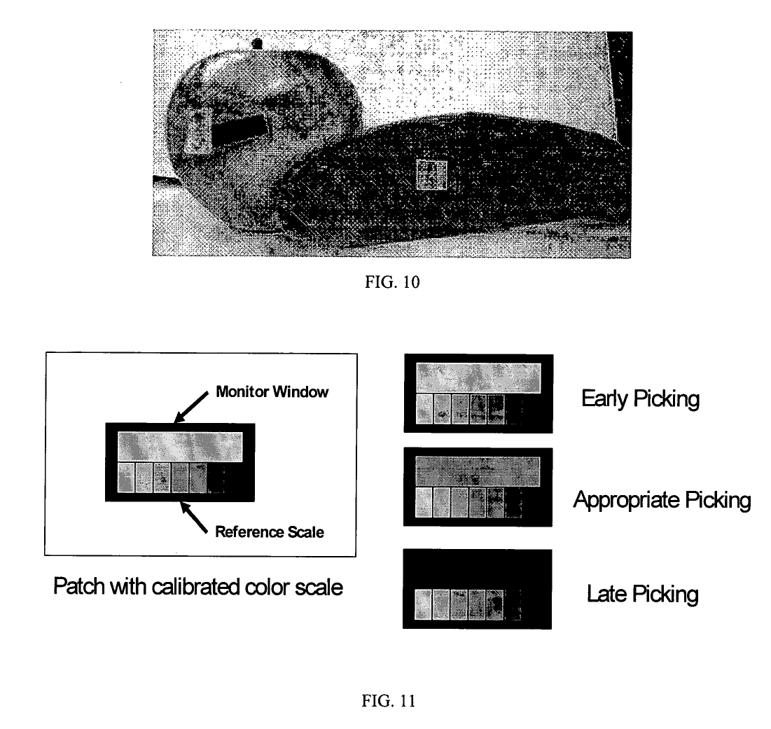

Moreover, FIG. 9 shows that an apparatus of the invention can also be calibrated to undergo a color change over a relatively longer time (e.g., 4 days). To ensure that the color changes are not due to something besides ethylene, a test using a negative control produce was performed. FIG. 10 illustrates an ethylene specificity test carried out on an apparatus of the invention, whereby a sticker embodiment of the invention is placed on an apple (left) and a prickly pear paddle (which does not release ethylene; right). While the sticker on the apple changes color, no substantial color change occurs on the sticker attached to the prickly pear paddle.

In a kit embodiment of the invention illustrated in FIG. 11, a color scale is placed next to the calorimetric reagent area to ease analysis of gradations in the color change. Hence, a plurality of ripeness indication sensors are provided in a kit to enable a user to sample selected produce or monitor all produce for multiple ripeness levels as depicted.

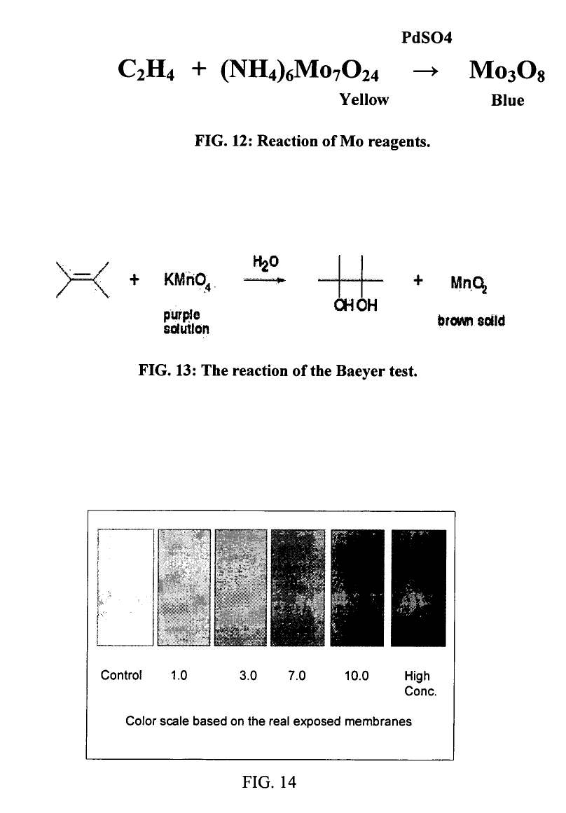

FIGS. 12 and 13 show chemical reactions that occur in some embodiments of the invention. Several reagents have been evaluated for the sensitivity to ethylene, their stability in the face of thermal and chemical variations, and their insensitivity to related chemicals. These reagents are encased, immobilized, or absorbed by a solid or semi-solid material (i.e., the substrate) that provides ease of use. The substrate is placed adjacent to or attached to a produce item and color evolves over minutes to hours to days, depending upon the type and strength of reagents employed and on the stage of the fruit maturity. Thus, the invention can be “fine tuned” to the temporal changes to provide separate devices that could work in the orchard or in the packing house on a variety of different produce items.

Preferred colorimetric reagents for use with the invention have included schemes involving reactions with metals such as molybdenum and manganese. Both liquid phase chemistries and solid phase chemistries have been tested. Liquid phase involves dissolving the reagents in a suitable solvent (such as water or acetone), introducing ethylene into the head space of a closed vial and then mixing. Solid phase methods involve precipitating or attaching reagents through covalent or ionic means to a solid support phase, which could be comprised of activated charcoal or silica (activated or otherwise), under an agarose layer, and on several membrane materials including Durapore,™ nitrocellulose, or polytetrafluoroethylene (PTFE). Especially preferred chemistries that have proven sensitive to ethylene include the following:

Scheme #1, Palladous sulfate (PdSO4) reacting with an ammonium molybdate compound and Scheme #2, Silicomolybdate protocol (NaSiF6) and an ammonium molybdate compound.

Several formulations of each Scheme have been prepared in a manner involving the following individual solutions:

Solution 1: PdSO₄ solution

Reagent

1. PdSO4 247.32 mg
2. H₂SO₄ (conc.) 3.5 ml
3. H₂O to fill 10 ml
   Procedure
1. weigh 247.32 mg PdSO₄ and add into a concentrated H₂SO₄ solution (3.5 ml).
2. heat gently until PdSO₄ dissolves into solution
3. add water until total volume of the solution is 10 ml
4. keep in cool (refrigerator; 4° C.) and dark place

Solution 2: Ammonium Molybdate solution ((NH₄)₆Mo₇O₂₄)

Reagent

1. Ammonium Molybdate: (NH₄)₆MO₇O₂₄*4H₂O 1 g
2. H₂SO₄ (concentrated) 0.28 ml
3. H₂O
   Procedure
1. add 0.28 ml of H₂SO₄ (concentrated) to H₂O and make the total volume of the solution up to 80 ml
2. dissolve 1 g of ammonium molybdate in H₂SO₄ solution (in No. 1)
2. add water until total volume of the solution is 100 ml
3. keep in cool and dark place
4. Note that this solution can also be made up in water, replacing the acid.

Solution 3: Sodium Silicofluoride solution (Na₂Si F₆)

Reagent

1. Sodium Silicofluoride: Na₂Si F₆ 0.09719 g
2. H2O
   Procedure
1. dissolve 0.09719 g of Na₂Si F₆ into H₂O and make the total volume of the solution up to 100 ml
2. Keep in cool and dark place

Solution 4: Ammonium Molybdate (NH₄)₂MoO₄
1. dissolve 5 g of ammonium molybdate in H₂SO₄ solution (from solution 1)
2. add water until total volume of the solution is 100 ml
3. keep in cool and dark place

Scheme #1: Palladous sulfate protocol

Procedure

1. Mix palladous sulfate solution (1) with ammonium molybdate solutions (2 or 4) in varying proportions ranging from 1:1 (Pd:Mo), 1:3, 1:10. Higher proportions of Mo solutions decrease degree of color change.
2. Place a small amount (5-15 μL) of solution on a suitable support material. 3. Dry slowly with a heat gun.

Scheme #2: Silicomolybdate protocol

Reagents

1. Ammonium molybdate solution (Solution 2 or 4) 1000 μl
2. Sodium silicofluoride (Solution 3) 2500 μl
   Procedure
1. Add solution 2 (or 4) 1000 μl into 2500 μl of solution B (alternative proportions below)
2. Keep in cool (refrigerator; 4° C.) dark place
3. May be stored for several days
4. Place a small amount (5-15 μL) of solution on a suitable support material.
5. Dry slowly with a heat gun.

Proportions of (NH₄MO: PdSO₄) of 1:3, 1:5 and 1:7 compound with 10, 30 and 50% of water have been evaluated. Results show that at 1:3 with 30 and 50% water produces a highly stable formulation.

Scheme #3: Ammonium molybdate

This method is derived from a publication from Shephard [1947]. We have evaluated two formulations of ammonium molybdate, following the general protocol laid out in the previous article. These formations are termed solutions P1 and P2.

Reagent

1. Ammonium Molybdate-tetrahydrate: (NH₄)₆Mo₇O₂₄*4H₂O 5 g for P1
2. Ammonium Molybdate, 99.98%: (NH₄)₂MoO₄ 5 g for P2
3. PdSO₄
4. H₂O
   Procedure for Ammonium Molybdate solution
1. To make P1, dissolve 5 g of ammonium molybdate from No. 1 in 100 ml of water
2. To make P2, dissolve 5 g of ammonium molybdate from No.2 in 100 ml of water
3. Keep in cool (refrigerator; 4° C.), dark place
   Procedure for solution
1. Mix 750 ml of water, 450 ml either P1 or P2 (ammonium molybdate solution), and 100 ml of PdSO₄
2. Keep in cool (refrigerator; 4° C.) and dark place
   This approach provides a stable chemistry which remains reactive to ethylene when the chemistries are coated onto activated silica gel. The activate silica gel after coating with the compound appears to be quite stable with a bright yellow color that turns blue after exposure to ethylene.

A number of materials may be used to encapsulate the calorimetric reagents, as long as they provide access for ethylene to the reagent and permit visual analysis. Preferably, the materials also substantially exclude water and oxygen transport. In embodiments of the invention featuring layers of substrate between which the calorimetric reagent is disposed, the other layer should be transparent or transleucent. Moreover, as a number of the reagents used with the invention display a strong ability to be oxidized in air, the outer membrane preferably should be oxygen impermeable, but clear.

Several simple materials have been evaluated for use as a substrate of the invention, including plastic wrap, Scotch-brand tape, and clear mailing tape. These materials proved suitable. The inner membrane of any multilayered embodiment must permit transport of ethylene from the fruit surface. Commercially available membranes that are feasible include nylon membranes (hydrophilic), 47 mm, 0.45 micron; Teflon-brand membranes (hydrophobic) 47 mm, 0.5 micron from Millipore; Durapore™ from Millipore, and nitrocellulose. The nylon is transparent, while the Teflon is not. For a solid phase reagent, either membrane would be reasonable for use. However, the opaque Teflon provides greater contrast and so is most appropriate for serving only as an inner membrane.

While the invention preferably is removably attached to a produce item, alternative configurations in which the substrate is not firmly attached, but, for example, is instead hung from a branch or by the fruit stem by a loop or hole in the substrate, are possible. The advantage with this approach is that adverse reactions with adhesives can be minimized.

While not meaning to limit the invention, the following examples illustrate exemplary embodiments and uses.

### EXAMPLE 1

All of the colorimetric reagents described above were tested by placing a small volume (5-15 uL) on several substrates, including filter paper, porous membranes, paper, coated paper, Durapore,™ and nitrocellulose. This substrate was exposed to ethylene (from a gas cylinder and from ripening fruits, including apples, peaches, oranges, pears, and others). The color of the reagent exposed to ethylene was then compared to that of unexposed control indicators. Color evolution began seconds after placement of the substrate and continued for minutes to days, depending on reagents applied and on the concentration of ethylene.

As seen in FIG. 8, substrates containing the KMnO₄ reagents were placed on an apple and evaluated immediately after placement, after 6 hours, and after 24 hours. Note the strong change in color over time from purple to brown, indicating substantial ethylene release.

The sensors of the invention respond to as little as 0.1 ppm of ethylene, although the most reliable responses are obtained for ethylene concentrations of 1 ppm or higher. The sensor response can be tailored based on proportion of constituents of the reagents (described in detail below), on the substrate material (membranes or granular systems), and on the preparation methods. Performance of the colorimetric reagent(s) also can be selected or modified to match the conditions (orchard, packing house, store display, etc.).

The desired performance metrics for the sensors developed according to the location of use include: (1) fast response to high levels of ethylene (i.e., a device that responds to a minimum of 1 ppm ethylene with a color change in less than 10 minutes). This sensor would be utilized primarily in the orchard; and (2) slow response to low levels of ethylene (i.e., response over the span of weeks to months and showing a degree of color change that integrates the slow release of ethylene during long term fruit storage under conditions designed to minimize ethylene release). It is preferable that in either case the device of the invention be impervious to interfering factors (moisture, carbon dioxide, low or high temperature, sunlight, etc.).

### EXAMPLE 2

Two different types of reagents, based on color changes of KMnO4 and Molybdenum blue, are tested. These are implemented in two configurations: membranes or precipitated on activated silica (labeled (1) and (2) below).

(1) Ethylene is readily oxidized by potassium permanganate (KMnO4) to form manganese oxide and ethylene glycol. During the oxidation of ethylene, the purple permanganate solution changes to a brown suspension of MnO2, this reaction, also known as the Baeyer Test, is used to detect unsaturated hydrocarbons (FIG. 13).

(2) In the presence of a reducing agent such as ethylene, the color of a molybdenum reagent catalyzed by palladium sulfate changes from pale yellow to blue (approximate composition Mo₃O₈). This approach is similar to the commercial ethylene Kitagawa detection tube's reaction. We have evaluated various formulations of palladium-catalyzed molybdate oxides, based on reviews of the literature and the reaction of the commercial ethylene detection tube, to determine the effect of changes of the proportions of ammonium molybdate and palladium sulfate on the stability and sensitivity of the reaction. The color change of the reagents is strong and fast when exposed to ethylene. These reagents are very sensitive to ethylene, and can detect ethylene at concentrations from 0.1-100 ppm.

The most successful sensors to date have utilized the Mo chemistry; however, in order to best optimize the timing of response, multiple arrangements can be utilized. The KMnO4 system has a lower sensitivity to ethylene and so is ideal for a slow reacting sensor.

Sensor formulations developed according to the invention vary in proportions and amounts of each reagent so as to develop a panel of devices with high sensitivity and with long time responses. Solution volumes, pH, salt content, and the final dryness of the device will be varied. Substrate (also called membrane materials) including several commercial and modified membranes along with activated silica are employed (see Table 1, below). It has been previously found that varying these reagent proportions, membrane materials, and volume of reagents can alter both the sensitivity of the device and the timing of the response.

TABLE 1
Description of membrane requirements.

| | | | | | Max. |
|---|---|---|---|---|---|
| Types of | | | | Wetta- | temp. |
| membrane | Composition | Qualities | Color | bility | (° C.) |
| Nitrocel- | Mixed | Widely use in | opaque | Hydro- | 75 |
| lulose | cellulose | analytical and | white | philic | |
| | esters | research | | | |
| | | applications | | | |
| | | Pore size: | | | |
| Durapore | Polyvinyl- | broad chemical | opaque | Hydro- | 85 |
| | idene | compatibility | white | philic | |
| | fluoride | Pore size: | | | |
| | | Mesh size: 125 | | | |
| | | μm | | | |
| Fluoro- | Supported | broad chemical | white | Hydro- | 130 |
| pore | PTFE bonding | compatibility | | phobic | |
| membrane | to | Pore size: | | | |
| | polyethylene | | | | |
| Nylon | Nylon | Compatible with | | Hydro- | 75 |
| | | a broad range | | philic | |
| | | of solvents | | | |
| | | Pore size: 0.22 | | | |
| | | and 0.45 μm | | | |
| | | Mesh size: | | | |
| | | 11-180 μm | | | |
| Qualita- | Cellulose | Use for clari- | opaque | Hydro- | N/A |
| tive | | fying liquid | white | philic | |
| Filter | | Diameter: 150 | | | |
| Paper | | mm | | | |
| Fiber | | Inorganic | Opaque | Hydro- | |
| Glass | | reagent | white | philic | |
| Tyvek | Spundbonded | Ultraviolet | opaque | Hydro- | N/A |
| | Olefin | light | white | philic | |
| | | resistance | | | |
| Nucle- | Microporous | Transparent | | Hydro- | 140 |
| pore | Polycarbonate | and smooth | | philic | |
| Polycar- | film | flat surface | | | |
| bonate | | | | | |
| Polyte- | PTFE on a | Wide chemical | opaque | Hydro- | 60 |
| trafluor- | polypropylene | and temp. | white | phobic | |
| oeth- | support | compatibility | | | |
| ylene | | Diameter: | | | |
| (PTFE) | | 5.0 cm | | | |

### EXAMPLE 3

We have developed a color scale by using the color of membranes exposed to various concentrations of ethylene (FIG. 14). This color scale serves as a guide for correlation of color change with ethylene concentration for a specific produce item, apples.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. An apparatus for indicating produce ripeness, comprising:
an ethylene-permeable substrate;
means for locating said substrate adjacent to a surface of said produce; and
a calorimetric reagent disposed upon said substrate, wherein said colorimetric reagent changes color in response to ethylene from said produce.

2. The apparatus of claim 1, wherein said means for locating said substrate comprises an adhesive disposed thereon for adherence of said substrate to said produce.

3. The apparatus of claim 1, wherein said means for locating said substrate comprises a loop structure or hole for hanging the substrate adjacent to said produce.

4. The apparatus of claim 3, wherein said loop structure is elastic.

5. The apparatus of claim 1, wherein said calorimetric reagent selected from the group consisting of palladium sulfates, ammonium molybdates, and silicomolydates.

6. The apparatus of claim 1, wherein said colorimetric reagent comprises KMnO₄.

7. The apparatus of claim 1, wherein said substrate further includes a color reference scale disposed thereon.

8. The apparatus of claim 7, wherein said color reference scale is calibrated to a level of ethylene emission corresponding to degrees of ripeness for a particular item of produce.

9. The apparatus of claim 1, wherein said colorimetric reagent is a solid phase or liquid phase reagent.

10. The apparatus of claim 1, wherein said substrate substantially excludes moisture and ultraviolet light transmission from contacting said colorimetric reagent.

11. A method for monitoring produce ripeness, comprising the steps of:
a. placing an ethylene-permeable and colorimetric reagent-containing substrate adjacent to a surface of said produce; and
b. ascertaining an ethylene-related color change in said reagent corresponding to a predetermined degree of ripeness.

12. The method of claim 11, wherein said step (a) further includes removeably adhering said substrate to said surface of said produce.

13. The method of claim 11, wherein said step (a) further includes hanging said substrate adjacent to said produce.

14. The method of claim 11, wherein step (a) further comprises a method for sampling ripeness whereby said substrate is placed adjacent to a subset of said produce.

15. The method of claim 11, wherein step (a) includes providing a colorimetric reagent selected from the group consisting of palladium sulfates, ammonium molybdates, and silicomolydates.

16. The method of claim 11, wherein step (a) comprises providing the calorimetric reagent KMnO₄.

17. The method of claim 11, further including the step of providing a color reference scale for determining a degree of ripeness.

18. The method of claim 17, further including the step of calibrating said color reference scale to a level of ethylene emission corresponding to a degree of ripeness for a particular item of produce.

19. The method of claim 11, wherein step (a) includes providing a solid or liquid phase calorimetric reagent.

20. The method of claim 11, wherein steps (a) and (b) are performed in situ.

21. A kit for indicating produce ripeness, comprising:
a plurality of ethylene-permeable sensors containing a colorimetric reagent, wherein said colorimetric reagent changes color in response to ethylene from said produce; and
a color reference scale depicting colors corresponding to degrees of ripeness.

22. The kit of claim 21, wherein said sensors and said color reference scale are disposed upon a common substrate.

23. An apparatus for indicating produce ripeness, comprising:
an ethylene-permeable inner substrate;
a colorimetric reagent disposed upon said inner substrate, wherein said colorimetric reagent changes color in response to ethylene from said produce;
an outer substrate disposed atop said reagent, wherein said calorimetric reagent is visually perceptible through said outer substrate; and
means for locating said apparatus adjacent to a surface of said produce.

24. The apparatus of claim 23, wherein said inner substrate further comprises an adhesive disposed thereon for adherence of said inner substrate to said produce.

25. The apparatus of claim 23, wherein said apparatus further comprises adhesive flaps coupled to one or both of said substrates for removably adhering said apparatus to said produce.

26. The apparatus of claim 23, wherein said means for locating said substrate adjacent to a surface of said produce includes a loop structure or hole for placing said apparatus adjacent to said produce.

27. The apparatus of claim 23, wherein said inner substrate includes a colorimetric reagent disposed thereon and selected from the group consisting of palladium sulfates, ammonium molybdates, and silicomolydates.

28. The apparatus of claim 23, wherein said colorimetric reagent comprises KMnO4.

29. The apparatus of claim 23, wherein said apparatus further includes a color reference scale disposed thereon.

30. The apparatus of claim 29, wherein said color reference scale is calibrated to the level of ethylene emission corresponding to degrees of ripeness for a particular item of produce.

31. The apparatus of claim 23, wherein said calorimetric reagent is a solid phase or liquid phase reagent.

32. The apparatus of claim 23, wherein said inner and said outer substrate substantially exclude moisture and oxygen from contacting said colorimetric reagent.

33. The apparatus of claim 23, wherein said outer substrate is ultraviolet light and gas impermeable.
